(19) United States
(12) Patent Application Publication
(10) Pub. No.: US 2016/0140469 A1
(43) Pub. Date: May 19, 2016

(54) METHOD AND SYSTEM FOR DISPATCHING RESOURCES

(71) Applicant: Alibaba Group Holding Limited, George Town (KY)

(72) Inventor: Yueyang Chen, Hangzhou (CN)

(21) Appl. No.: 14/943,381

(22) Filed: Nov. 17, 2015

(30) Foreign Application Priority Data
Nov. 19, 2014 (CN) 201410662583.4

(51) Int. Cl. G06Q 10/06

(52) U.S. Cl. CPC G06Q 10/06313

(57) ABSTRACT

Dispatching resources is disclosed including acquiring first configuration information of a first resource warehouse and second configuration information of a second resource warehouse, determining configuration match information of the first resource warehouse and the second resource warehouse based on the first configuration information and the second configuration information, and in the event that the configuration match information exceeds a predetermined configuration match threshold value, establishing a corresponding third resource warehouse based on the configuration match information, the third resource warehouse including resources in the first resource warehouse and the second resource warehouse.

### CROSS REFERENCE TO OTHER APPLICATIONS

This application claims priority to People's Republic of China Patent Application No. 201410662583.4 entitled A METHOD AND EQUIPMENT FOR DISPATCHING RESOURCES, filed Nov. 19, 2014 which is incorporated herein by reference for all purposes.

### FIELD OF THE INVENTION

The present application relates to a method and system for dispatching resources.

### BACKGROUND OF THE INVENTION

Conventional warehouse management systems employ a relatively narrow range of resource allocation techniques. Typical conventional techniques either individually select an exclusive resource warehouse (e.g. physical warehouse) to allocate resources (e.g., goods) or individually select a shared resource warehouse to allocate resources. If the former technique is adopted, the resource allocation coverage range is typically limited because of limited allocation capability of the exclusive resource warehouse. In the latter technique, resources input by the resource allocator into the shared resource warehouse may not be capable of meeting actual resource allocation needs (e.g., the shared resource warehouse does not have enough resources to meet requests), resulting in low resource allocation efficiency.

### BRIEF DESCRIPTION OF THE DRAWINGS

Various embodiments of the invention are disclosed in the following detailed description and the accompanying drawings.

FIG. 1 is a diagram of an embodiment of a device for dispatching resources.

FIG. 2 is a flowchart of an embodiment of a process for dispatching resources.

FIG. 3 is a diagram of an embodiment of a system for dispatching resources.

FIG. 4 is a functional diagram illustrating an embodiment of a programmed computer system for dispatching resources.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

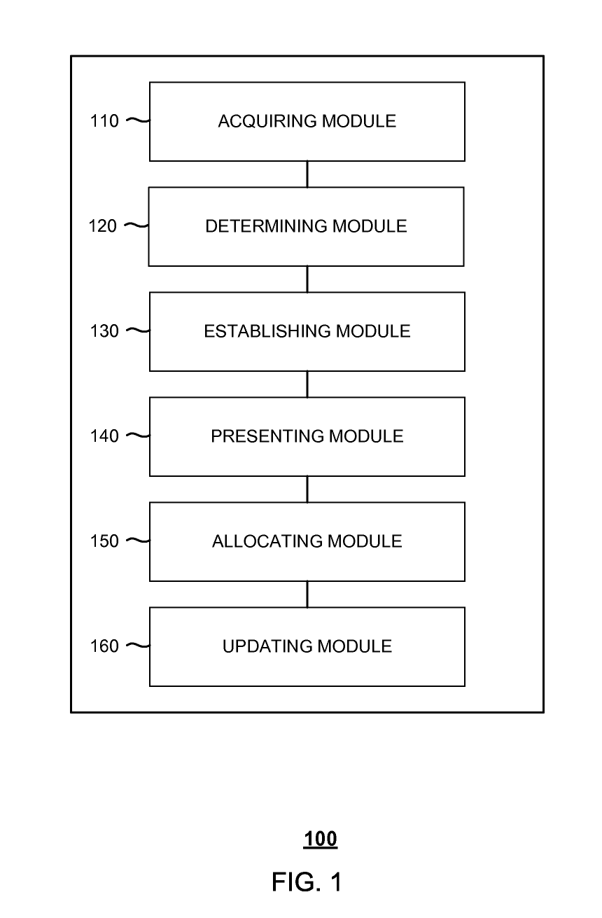

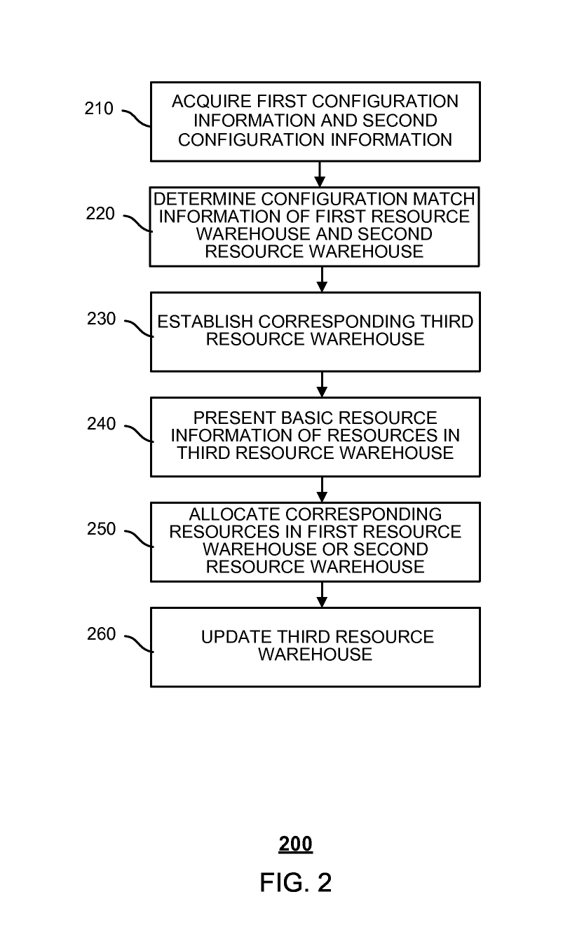

FIG. 1 is a diagram of an embodiment of a device for dispatching resources. In some embodiments, the device 100 is configured to implement process 200 of FIG. 2 and comprises: an acquiring module 110, a determining module 120, and an establishing module 130.

In some embodiments, the acquiring module 110 is configured to acquire first configuration information of a first resource warehouse and second configuration information of a second resource warehouse. The determining module 120 determines configuration match information of the first resource warehouse and the second resource warehouse based on the first configuration information and the second configuration information. In some embodiments, the establishing module 130 establishes a corresponding third resource warehouse based on the configuration match information. In some embodiments, the third resource warehouse includes resources of the first resource warehouse and the second resource warehouse.

For example, the acquiring module 110 acquires the first configuration information of the first resource warehouse and the second configuration information of the second resource warehouse. The first resource warehouse and the second resource warehouse each store a certain quantity of same target resources. The target resources include real resources and virtual resources. An example of a virtual resource includes charge cards used in games. For example, the first resource warehouse and the second resource warehouse each store some merchandise that is in the same category and merchandise from the same merchant (e.g., both warehouses store the same brand of shoes). In some embodiments, the first resource warehouse engages in simultaneous online-offline dispatching of the target resources. For example, the first resource warehouse is an exclusive resource warehouse whereby a merchant stores target merchandise. The merchant can engage in online transactions involving the target merchandise based on the first resource warehouse. The merchant can also engage in synchronized transactions at its stores. With respect to the second resource warehouse, the merchant is primarily engaged in online dispatching of the target resource. For example, the second resource warehouse is a shared resource warehouse managed by an electronic commerce (e-commerce) platform for the many merchants that take part in transactions on the e-commerce platform. The acquisition of target resources in the second resource warehouse can be the same as the acquisition of target resources in the first resource warehouse and originate from production from the manufacturer or purchasing by the merchant. The acquisition of target resources in the second resource warehouse can include directly obtaining the target resources from the corresponding first resource warehouse, e.g., obtaining the target resources from an exclusive resource warehouse of the merchant, such as at fixed or irregular times, dispatching the target resources from an exclusive resource warehouse to a corresponding shared resource warehouse. Furthermore, both the first resource warehouse and second resource warehouse corresponding to the target resources can store one or more of the target resources. For example, the merchant has multiple exclusive resource warehouses for merchandise of the same category with each resource warehouse providing storage. In another example, the merchant separately deposits (e.g., physical stores) merchandise of the same category into multiple shared resource warehouses managed by a single electronic transaction platform. In yet another example, the merchant separately deposits merchandise of the same category into multiple shared resource warehouses managed by different single electronic transaction platforms.

In addition, the first configuration information corresponding to the first resource warehouse includes some basic information of the first resource warehouse, e.g., the resource distribution coverage range corresponding to the first resource warehouse or area information for a location of the first resource warehouse. Similarly, the second configuration information of the second resource warehouse includes some basic information of the second resource warehouse. Moreover, in some embodiments, the first configuration information and the second configuration information are compatible and consistent with regard to their types. Various types of configuration information include warehouse delivery area, warehouse coverage range, warehouse address, etc. For example, delivery ranges of the first and second warehouses are the same type of information. For example, if the resource distribution coverage range of a merchant's exclusive resource warehouse corresponds to the first configuration information, then the second configuration information should correspond to the resource distribution coverage range of the shared resource warehouse corresponding to the merchant. The acquiring module 110 acquires and records first configuration information of the first resource warehouse and second configuration information of the second resource warehouse.

Next, the determining module 120 is configured to determine configuration match information of the first resource warehouse and the second resource warehouse based on the first configuration information and the second configuration information. Categories of the configuration information corresponding to the first resource warehouse and the second resource warehouse can be consistent. The configuration match information includes results of comparing and relating the first configuration information with the second configuration information. For example, the distribution coverage range of the first resource warehouse corresponds to the first configuration information, and the distribution coverage ranges include A1, A2, C1 and C2. The distribution coverage range of the second resource warehouse corresponds to the second configuration information, and the distribution coverage ranges include B1, B2, C1 and C2. Regions A, B, and C represent the coverage regions of the warehouses, e.g., region A corresponds with the Chicago metro area, region B corresponds with the Houston metro area, region C corresponds with the Philadelphia metro area, and, for example, A1 and A2 represent distribution coverage ranges of 2 different resource warehouses within region A. A comparison of the distribution coverage ranges of the first and second resource warehouses is performed to determine a distribution coverage overlap between the distribution coverage ranges of the first and second resource warehouses. Thus, the determining module 120 can obtain an overlapping distribution coverage range of the first resource warehouse and the second resource warehouse being C1 and C2. The determining module 120 can analyze the overlap information of the configuration coverage range and determine definite configuration match information. For example, regarding the first and second resource warehouses, 50% of the area of their distribution coverage ranges is overlapping. Therefore, the determining module 120 can determine distribution coverage range overlap ratio based on the configuration match information of the first and second resource warehouses. Furthermore, if the number of distribution areas corresponding to the first resource warehouse and the second resource warehouse exceeds a threshold, then a sampling method can be employed to conduct localized determinations. For the overlapped parts, conducting a localized determination includes performing sampling, and after the sampling is performed, determining whether a distribution area meets the requirements to establish a third resource warehouse. In another example, the area information of the first resource warehouse location corresponds to the first configuration information, e.g., the first resource warehouse is in place E. The area information of the second resource warehouse location corresponds to the second configuration information, e.g., the second resource warehouse is in place F. Thus, the configuration match information of the first resource warehouse and the second resource warehouse can be set as the relatedness between places E and F, where the two resource warehouses are located. The relatedness between places E and F can be comprehensively analyzed and determined from multiple parameters such as the distance between the two areas and the time needed to go from place E to place F via a certain mode of transportation. For example, the locations of two resource warehouses, e.g., the distance between two resource warehouses is short, and travel is easy, and the goods replacement time between the two resource warehouses is short (e.g., complete goods replacement can occur within 2 days from resource warehouse A to resource warehouse B, or from resource warehouse B to resource warehouse A). Accordingly, the relatedness between the two resource warehouses can be calculated based on the distance between the two resource warehouses and the goods replacement time. The role herein of the configuration match information includes providing a basis for the reasonableness of merging the first and second resource warehouses.

In some embodiments, the device 100 further comprises an updating module 160. The updating module updates a third resource warehouse based on offline resource allocation information of the first resource warehouse. Because the first and second resource warehouses can be virtual warehouses (e.g., e-commerce platform) and/or physical warehouses, and can simultaneously sell goods, the third resource warehouse can include virtual and/or physical goods.

As an example, the corresponding target resources in the first resource warehouse include two kinds of dispatch modes: online and offline. For example, the first resource warehouse combined with the corresponding second resource warehouse establishes the matching third resource warehouse. Resources of the first resource warehouse can be provided online in response to resource allocation requests from users having online needs. At the same time, the first resource warehouse can also perform offline transactions. For example, the first resource warehouse is an exclusive resource warehouse where a merchant stores target merchandise. The merchant can engage in online transactions involving the target merchandise based on the resource warehouse. The merchant can also engage in synchronized transactions at its stores. Synchronized transactions relate to online or offline transactions. For offline transactions, if there is a physical warehouse for the seller, the consumer can go to the warehouse to buy products. For online transactions, the seller can sell online, and a consumer can go to the seller's website to purchase products stored in a physical warehouse. In this case, information relating to the offline resource allocations conducted by the first resource warehouse is to be updated to the third resource warehouse. For example, inventory changes caused by offline allocations are reported in real time in the electronic transaction platform system corresponding to the third resource warehouse. The simultaneous offline-online dispatching by the first resource warehouse enriches modes of resource allocation and increases resource dispatching capabilities and resource utilization rates. The real-time updating of simultaneous online-offline resource allocation information also prevents problems such as incompatibilities that may occur in the resource information of the target resources.

In some embodiments, the determining module 120 is configured to determine configuration match information of the first resource warehouse and the second resource warehouse based on the first configuration information, the second configuration information, and resource need distribution information of the first resource warehouse and the second resource warehouse, respectively. In some embodiments, the resource need distribution information relates to an area or a location where merchandise is to be sent.

In another example, the role of the configuration match information includes performing a dispatch for the first and second resource warehouses, e.g., providing reference information on whether to merge, how to merge, or perform other such operations. For example, the determining module 120 compares all the distribution areas of the first resource warehouse and the second resource warehouse, respectively, and determines the overlap (e.g., an overlap ratio) of the distribution areas. Furthermore, in some embodiments, the configuration match information is determined based on the resource need distribution information of the first resource warehouse and the second resource warehouse, respectively. The resource need distribution information can be determined according to historical resource allocation information of the corresponding resource warehouse. Moreover, parameter information such as resource categories and need time segments can be incorporated into the resource need distribution information. An example of the historical resource allocation information is transaction volume of a type of merchandise within a holiday period in the first resource warehouse or the second resource warehouse. At this point, each resource warehouse can have multiple distribution areas, but each distribution area would differ with respect to target resource need. Some distribution areas are to exceed other distribution areas with respect to the needs of some target resources. Furthermore, the configuration match information is not only used to compare the areas of the first resource warehouse and the second resource warehouse to determine the distribution coverage overlap, but the configuration match information can also include target resource need quantity information from resource warehouses in the overlapping portions. For example, the configuration match information includes two parts: first, the degree of distribution overlap in two resource warehouse's distribution coverage areas, if the two resource warehouses' distribution coverage overlap covers at least 70% of the consumers, then these two warehouses can be combined into a third resource warehouse; and second, if the overlap of products in the two resource warehouses is at least 70%, the two resource warehouses can be combined into a third resource warehouse. The higher the distribution coverage overlap between the distribution coverage ranges of each resource warehouse, the higher the amount of overlap there will be (and therefore the higher the amount of configuration match), and thus, following subsequent dispatching adjustments, such as resource warehouse merging, the more dispatchable resources there will be. Likewise, the greater the demand for resources of the overlapping portion, the greater the benefit of resource allocation is to occur due to the improved resource dispatching. As an example, one can set weights for the configuration information, such as resource distribution areas, of the first resource warehouse and the second resource warehouse. Areas with large resource needs would have higher weights. This would mean that the configuration match information of the first resource warehouse and the second resource warehouse would be correspondingly higher.

Next, the establishing module 130 is configured to establish a corresponding third resource warehouse based on the configuration match information. In some embodiments, the third resource warehouse includes resources in the first resource warehouse and the second resource warehouse. In order to set up certain configuration information for the first resource warehouse and the second resource warehouse, and while conducting comparisons and analyses to obtain the configuration match information, the first resource warehouse and second resource warehouse corresponding to the configuration match information that has met certain conditions are subject to dispatch consolidation based on actual resource dispatch conditions and objectives. For example, the first and second resource warehouses undergo a resource merger to establish a corresponding third resource warehouse. In some embodiments, the third resource warehouse can be a virtual resource warehouse that does not store physical goods but instead maintains inventory and other information of the resources and supports transactions. Moreover, after the resources of the first resource warehouse and the resources of the second resource warehouse are combined, the combined resources serve as resources of the third resource warehouse. Using resource inventory information corresponding to a resource warehouse as an example, inventory of a target resource G of a certain merchant is M pieces in the first resource warehouse. The inventory of target resource G of the certain merchant is N pieces in the second resource warehouse. Thus, in the third resource warehouse that is established, the inventory of target resource G of the certain merchant is M+N pieces. In addition, if the configuration match information of the first resource warehouse and the second resource warehouse fails to meet a certain condition, the first resource warehouse and the second resource warehouse corresponding to the target resource can serve as two co-existing resource warehouses for the target resource. The configuration information and target resource information of each resource warehouse would be mutually independent. The resource dispatching of each resource warehouse can be conducted synchronously. For example, for resource allocation requests, request A could request K pieces of target resources in the first resource warehouse, while request B could request L pieces of target resources in the second resource warehouse. At this point, although a corresponding third resource warehouse has not been established, the simultaneous dispatching of the first resource warehouse and the second resource warehouse offers improved performance over the conventional allocation method in which only selecting one resource warehouse for dispatching was possible.

In some embodiments, when the configuration match information exceeds a predetermined configuration match threshold value, the establishing module 130 establishes a corresponding third resource warehouse. In some embodiments, the third resource warehouse includes the resources of the first resource warehouse and the second resource warehouse.

In some embodiments, the configuration match information corresponding to the first resource warehouse and the second resource warehouse can serve as basic information for resource dispatching adjustments. When a certain condition or set of conditions is met, the resources are consolidated, e.g., resource warehouses are merged. In some embodiments, the conditions include a predetermined configuration match threshold value. The configuration match threshold value corresponds to configuration match information of each resource warehouse. For example, the configuration match information of the resource warehouses corresponds to distribution coverage ranges of the first resource warehouse and the second resource warehouse, as in the following: the distribution coverage overlap of the first resource warehouse and the second resource warehouse is 50%. Thus, the configuration match threshold value should be a certain numerical value that relates to the resource distribution coverage ranges, e.g., a 40% distribution coverage overlap, or a 60% distribution coverage overlap. The condition can then be set so that when the configuration match information exceeds the predetermined configuration match threshold value, the establishment of a corresponding third resource warehouse is to be triggered. As an aspect, when the configuration match information does not exceed the predetermined configuration match threshold value, the first resource warehouse and the second resource warehouse are to each remain independent. For example, in the above example, if the configuration match threshold value is set to a distribution coverage overlap of 40%, then a 50% overlap between the resource distribution coverage ranges of the first resource warehouse and the second resource warehouse can satisfy the condition for establishing a corresponding third resource warehouse. However, if the configuration match threshold value is set to a distribution coverage overlap of 60%, then a 50% distribution coverage overlap between the resource distribution coverage ranges of the first resource warehouse and the second resource warehouse fails to satisfy the condition for establishing a corresponding third resource warehouse. In another example, the configuration match information of the resource warehouse corresponds to the area information of the first resource warehouse and second resource warehouse locations: the first resource warehouse is located at place E and the second resource warehouse is located at place F. If the relatedness between the two places relates to a numerical value based on the actual distance between the two places, then in this case the configuration match threshold value also corresponds to a numerical value for degrees of relatedness between resource warehouse areas. At this point, the specific data information can be screened and acquired from historical resource allocation information. At the same time, factors considered in setting the configuration match threshold value can be flexibly set based on different conditions of each resource warehouse in actual dispatching. The following is an example when the configuration match threshold value relates to resource distribution coverage ranges: if the geographical overlap of the areas corresponding to the first resource warehouse and second resource warehouse is not high, but resource needs corresponding to the overlap area are very high, then a lower configuration match threshold numerical value can be set to trigger the establishment of a merged third resource warehouse. As a result, meeting higher resource needs based on the merged target resources is possible. In another example, the first resource warehouse and the second resource warehouse have distribution coverage ranges having non-overlapping portions that are relatively far from each other. If the resource warehouses are merged, and the subsequent dispatching cost between the resource warehouses is relatively high, then the configuration match threshold numerical value can be set to a higher value to minimize the proportion of non-overlapping distribution coverage ranges between the first and second resource warehouses corresponding to the established third resource warehouse. Higher costs resulting from dispatching between the resource warehouses can thus be avoided. The rationale for using a predetermined configuration match value to define the conditions for merged resource warehouse dispatching is to make dispatching more efficient, dispatchable resources more plentiful, and reduce costs.

In some embodiments, when the configuration match information exceeds a predetermined configuration match threshold value that corresponds to a resource category, the establishing module 130 establishes a corresponding third resource warehouse. In some embodiments, the third resource warehouse includes resources of the resource category in the first resource warehouse and the second resource warehouse.

For example, in actual applications, categories of target resources stored in the first resource warehouse and the second resource warehouse are not limited to one kind For different target resources in a unified resource warehouse, different types of configuration information can be set up for the different target resources. Using the resource distribution coverage ranges as an example, a single resource distribution coverage range can be applied to all resources within one resource warehouse. Individually setting up distribution coverage ranges corresponding to different resource categories is possible. For example, the first resource warehouse simultaneously has target resources of category X, category Y, and category Z. Correspondingly, different types of configuration information can be set for different categories of target resources. For example, the distribution coverage range of category X target resources in the first resource warehouse can be defined as “all distributable in area P,” which corresponds to the first resource warehouse. For the distribution coverage range for category Y target resources, the distribution coverage range for category Y can be defined as just “partially distributable in area P1,” which corresponds to the first resource warehouse, and the distribution coverage range for category Z target resources can be defined as just “partially distributable in area P2,” which corresponds to the first resource warehouse. The P1 and P2 are subsets of distributable area P. By the same principle, the target resources of each category in the second resource warehouse are to also have their corresponding specific configuration information. Furthermore, based on the configuration information corresponding to each category of the target resource in the resource warehouse, configuration match threshold values are preset corresponding to the resource categories. When each category of merchandise in a resource warehouse understandably has a distribution area-related bias, setting things up in such a differentiated way can more flexibly adapt to resource dispatching and allocation needs in actual applications. For example, the configuration information for the entirety of resources in the first resource warehouse includes the New York metro area and the Los Angeles metro area. In some embodiments, category U merchandise is mostly concentrated in the New York metro area, and category V merchandise is mostly concentrated in the Los Angeles metro area. In this case, for the sake of more efficient and centralized distribution of resources, the configuration information for the category U merchandise in the first resource warehouse can be set as the New York metro area, and the configuration information for category V merchandise can be set as the Los Angeles metro area. Then, when the target resources U and V in the first resource warehouse undergo configuration match information determination in relation to target resources U and V in the second resource warehouse, if the configuration match information is a distribution coverage overlap, the configuration information characteristics of target resources U and V will be apparent. For example, the configuration information characteristics relate to a distance between two addresses, how well-developed the transportation system is, how close the two addresses are, etc. A third resource warehouse will be established when the configuration match threshold value is met, and resource dispatching will become better targeted. When the resource categories in certain resource warehouses have known distribution area-related biases, resource warehouse configuration information and configuration match threshold values are set up that correspond to resource categories. This allows more flexible allocation of resource dispatching effectiveness throughout the resource warehouses and leads to increased matches between needs and resources.

By matching the first resource warehouse and the second resource warehouse corresponding to the same resource based on the configuration match information of each category, a third resource warehouse that simultaneously contains the resources of the first resource warehouse and second resource warehouse and thus expands and adjusts the allocation range of the target resources can be established. In this way, resource allocation efficiency is increased with respect to conventional resource allocation methods.

In some embodiments, the device 100 further includes a presenting module 140. In some embodiments, the presenting module 140 presents basic resource information of resources in the third resource warehouse.

For example, the basic resource information includes resource category information of the third resource warehouse, inventories of the resources, sources of resource inventories, information on resource allocations that have already occurred, etc. The basic resource information of resources in the third resource warehouse is a summation and merger of the basic resource information including resources in the first resource warehouse and the second resource warehouse. Many ways in which the basic resource information can be presented exist. One presentation example can be on a network user terminal, such as a computer or a mobile network terminal, providing the basic resource information of target resources in the third resource warehouse to a user in need. For example, if the basic resource information corresponds to resource inventory, then the inventory information on resources in the third resource warehouse includes a sum of inventory information of corresponding resources in the first resource warehouse and the second resource warehouse, which can be merged and provided to the user in need. To provide another presentation example, the basic resource information contains resource inventory source information in the third resource warehouse. For example, the areas and other related information for the first resource warehouse and the second resource warehouse corresponding to the third resource warehouse of the resource sources exist, and inventory information relating to each individually exists. At the same time, depending on the allocation and dispatching conditions of the resources, the resource inventory in the resource warehouse can be updated in real time. Thus, users in need can be provided with relatively comprehensive basic resource information as a reference. For example, a certain type of merchandise in place S is produced with the best quality. In that case, the user learns through a webpage that the target resource warehouse of the merchandise is place S. As an example, the first, second, and third resource warehouses each have their own delivery area. The system can use the user's delivery address to locate the appropriate resource warehouse based on the warehouses' corresponding delivery areas. Assuming that the target resource warehouse address has a definite possibility of being related to the merchandise place of origin, the user can, to a certain extent, place more trust in the target resource warehouse of the resource corresponding to place S than in target resource warehouses of other areas. Accordingly, this trust could lead to selection bias. In an actual application, another situation also exists. In other words, sometimes in order to provide users in need with the most streamlined user experiences, the specific real resource warehouse information that is associated with resources that are to be allocated may not be displayed at the application front end. For example, when merchandise information is viewed during an online transaction, basic resource information such as merchandise category and inventory can receive special attention, though the source resource warehouse information for the merchandise may not be displayed. Therefore, the specific types of basic resource information of resources in the third resource warehouse can be flexibly set based on specific application scenarios.

In some embodiments, the establishing module 130 also determines third configuration information of the third resource warehouse based on the first configuration information and the second configuration information. In some embodiments, the presenting module 140 presents basic resource information of resources in the third resource warehouse and the third configuration information.

For example, the third resource warehouse includes the resources in the first resource warehouse and the second resource warehouse. In specific resource allocation and dispatching, the third configuration information of the third resource warehouse can include the configuration information corresponding to the target resources in the first resource warehouse and the second resource warehouse. For example, using the configuration information including the resource distribution coverage ranges as an example, the resource distribution coverage ranges corresponding to the first resource warehouse W1 are R1, R2, R3 and R4; the resource distribution coverage ranges corresponding to the second resource warehouse W2 are R1, R2, R5 and R6; and thus, the third configuration information of the third resource warehouse W3 is to have resource distribution coverage ranges R1, R2, R3, R4, R5 and R6. Furthermore, the presenting module 140 presents the basic resource information of the resources in the third resource warehouse and the third configuration information. For example, in the above basic resource information of the first resource warehouse W1, the inventory information is e1, and the inventory information of the second resource warehouse W2 is e2. Thus, presenting the target merchandise inventory quantity of e1+e2 to users in need through computer pages or mobile device terminals is possible. The corresponding configuration information can be distributed to areas R1, R2, R3, R4, R5, and R6. In addition, presenting, as necessary, the target merchandise inventory quantities and the correspondences to the resource warehouses to users in need for their browsing reference is also possible. For example, the inventory of target merchandise e1 corresponds to first resource warehouse W1 and is paired with the basic information of the first resource warehouse, etc.

In some embodiments, the device 100 further includes an allocating module 150. The allocating module 150 allocates corresponding resources in the first resource warehouse or the second resource warehouse based on resource allocation requests concerning resources in the third resource warehouse.

In some embodiments, the third resource warehouse includes virtual resources comprising the resources in the first resource warehouse and the second resource warehouse. Please note that the same physical resource cannot appear in 2 different warehouses at the same time. In some embodiments, the basic resource information of resources in the third resource warehouse and the third configuration information are to be presented at the network front-end, e.g., a computer page or a portable terminal. Based on the resource-related information that is displayed, the user in need is to issue a corresponding resource allocation request. Typically, since the third resource warehouse is a virtual resource warehouse that maintains resource information regarding the physical resources in other physical warehouses, the resource allocation request that is made based on the basic resource information of the third resource warehouse and the third configuration information that are presented is to ultimately be routed to the ascertained real resource warehouse, such as the first resource warehouse or the second resource warehouse. With respect to the target resources of the request, corresponding resources are to be searched in the first resource warehouse or the second resource warehouse. Then the corresponding resources in the specific, routed-to resource warehouse are allocated. For example, the user, via an electronic transaction platform, browses the basic resource information and corresponding configuration information, such as merchandise inventory and specific shipment area ranges, for target merchandise displayed on a transaction web page. Moreover, the user issues a resource allocation request, e.g., places a shopping order. The system responds to the allocation request and determines and routes to an ascertained shipment warehouse based on the selected target merchandise in the allocation request. Arrangements are made to release and ship the corresponding target merchandise from the shipment warehouse.

In some embodiments, the allocating module 150 determines which of the first resource warehouse and the second resource warehouse is the corresponding target resource warehouse based on the resource allocation address corresponding to the resource allocation request. The corresponding resource in the target resource warehouse is allocated to the resource allocation address.

For example, the resource allocation address associated with the resource allocation request is ascertained. The resource allocation request can be, for example, a transaction order submitted by a user (e.g., a seller) on an electronic transaction platform while performing merchandise transactions. The determination of the resource allocation address is based at least in part on the resource allocation request issued by the user. The resource allocation request includes the categories and quantities and other information relating to request target merchandise. In addition, the user can select a resource allocation address based on a resource distribution coverage range managed by the system, e.g., distribution address options displayed by the merchandise information page. In another example, the system can automatically set the resource allocation address of the target merchandise selected by the target user. For example, the system fetches the default receiving address set by the target user and recorded on an electronic transaction platform or fetches the receiving address that appears most frequently in the transaction records of the user over a period of time and regards this receiving address as the resource allocation address associated with the resource allocation request. Based on the resource allocation address associated with the resource allocation request, the device 100 is to display for the consumer precise target merchandise information, e.g., the inventory of target merchandise that satisfies the resource allocation request. In some embodiments, the device 100 can also display information relating to the specific resource warehouse corresponding to the inventory. After the transaction order is confirmed by the user, the allocating module 150 is to determine which of the first resource warehouse or the second resource warehouse corresponding to the target merchandise is the corresponding target merchandise warehouse. Thereupon, the allocating module 150 allocates the resources that correspond to the resource allocation request and that are in the target resource warehouse to the resource allocation address.

In some embodiments, the allocating module 150, based on the specific target resource warehouse that was ascertained, allocates the resources associated with the resource allocation request through a second routing to the resource allocation address. First, based on the target merchandise and the resource allocation request corresponding to the target merchandise, a preliminary determination is made that the actual shipment warehouse is the third resource warehouse or that the actual shipment warehouse is an independent first resource warehouse or second resource warehouse that was not merged into a third resource warehouse, and the first routing information is recorded in the transaction order for the target merchandise. Furthermore, a logistics order for the corresponding target merchandise is created based on the transaction order and the consumer payment facts. A second routing is performed based on the warehouse information in the logistics order. If the logistics order only corresponds to an independent first resource warehouse or a second resource warehouse that was not merged into the third resource warehouse, then the logistics order is sent directly to the corresponding resource warehouse for arrangement of shipping matters. If the logistics order corresponds to the third resource warehouse of the target merchandise, then matching is performed based on the specific resource configuration address, and arrangements are made for shipping from either the first resource warehouse or the second resource warehouse corresponding to the target merchandise third resource warehouse. For example, the distribution coverage range of the first resource warehouse corresponding to the third resource warehouse is P1, P2 and P3, and the distribution coverage range of the corresponding second resource warehouse is P1, P2 and P4. If the resource allocation address corresponding to the current resource allocation request is P3, then the priority arrangement is to be for the first resource warehouse to serve as the target resource warehouse. If the resource allocation address is P4, then the priority arrangement is for the second resource warehouse to serve as the target resource warehouse. If the resource allocation address is P1 or P2, and both the first resource warehouse and the second resource warehouse have the corresponding inventory, then either the first resource warehouse or the second resource warehouse can be selected as the target resource warehouse. In some embodiments, a corresponding target resource warehouse can be selected based on actual operational convenience. Furthermore, the first resource warehouse and the second resource warehouse corresponding to the third resource warehouse can also engage in mutual, supplementary dispatching during actual resource dispatching. For example, in the above example, the resource allocation address corresponding to the resource allocation request is P3. In principle, priority should be given to arranging for the first resource warehouse to serve as the target resource warehouse. As an aspect, if at this time, the inventory of the target resource corresponding to said first resource warehouse is 0, and the inventory of the target resource corresponding to the second resource warehouse is m, then the second resource warehouse can be chosen to complete distribution of the target resource in order to complete the dispatching of the target resource. In some embodiments, one can choose to dispatch the corresponding target resource in the second resource warehouse to the corresponding first resource warehouse and then complete distribution of the target resource from the first resource warehouse.

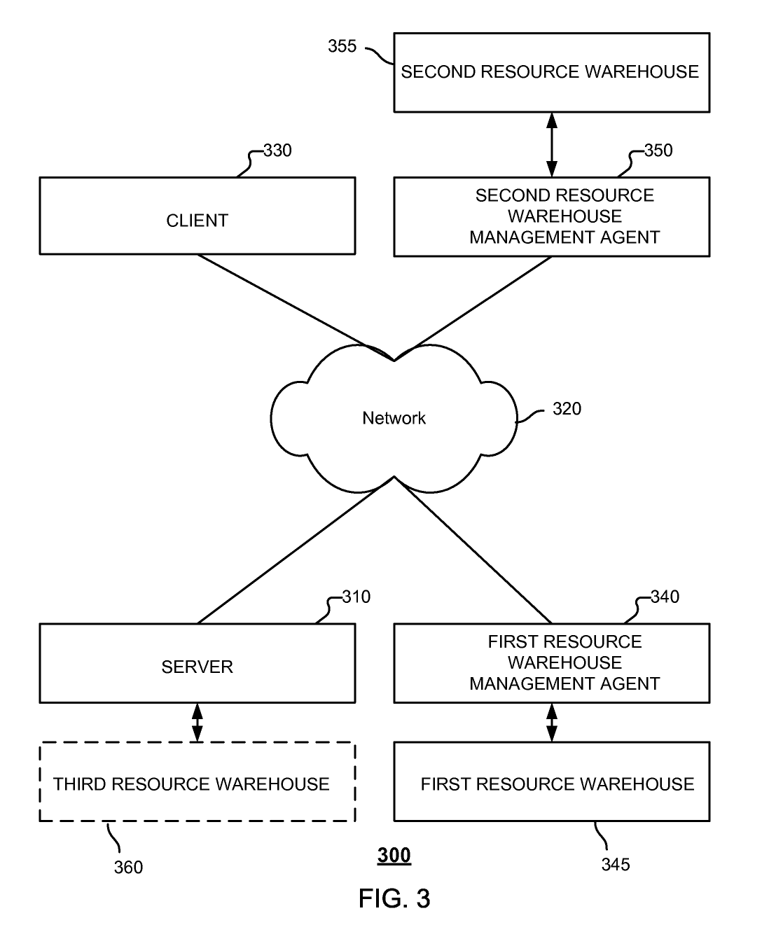

FIG. 2 is a flowchart of an embodiment of a process for dispatching resources. In some embodiments, the process 200 is implemented by a server 310 of FIG. 3 and comprises:

In 210, the server acquires first configuration information for a first resource warehouse and second configuration information for a second resource warehouse.

In 220, the server determines configuration match information of the first resource warehouse and the second resource warehouse based on the first configuration information and the second configuration information.

In 230, the server establishes a corresponding third resource warehouse based on the configuration match information, the third resource warehouse including the resources of the first resource warehouse and the second resource warehouse.

In some embodiments, in 210, the first configuration information of the first resource warehouse and the second configuration information of the second resource warehouse are acquired. The first resource warehouse and the second resource warehouse each store a certain quantity of the same target resources. The target resources include real resources, virtual resources, or a combination thereof. For example, the first resource warehouse and the second resource warehouse each store some merchandise that is in the same category and from the same merchant. In some embodiments, the first resource warehouse can engage in simultaneous online-offline dispatching of the target resources. For example, the first resource warehouse is an exclusive resource warehouse whereby a merchant stores a target merchandise. The merchant can engage in online transactions involving the target merchandise based on the resource warehouse. The merchant can also engage in synchronized transactions at its stores. Regarding the second resource warehouse, the second resource warehouse is primarily engaged in online dispatching of the target resource. For example, the second resource warehouse is a shared resource warehouse managed by an e-commerce platform for many merchants that conduct transactions. The acquisition of target resources in the second resource warehouse can be the same as the acquisition of target resources in the first resource warehouse and originate from production from the manufacturer or purchasing by the merchant. The acquisition of target resources of the second resource warehouse can include directly obtaining the target resources from the corresponding first resource warehouse, e.g., obtaining the target resources from an exclusive resource warehouse of the merchant, e.g., at fixed or irregular times dispatching the target resources from an exclusive resource warehouse to a corresponding shared resource warehouse. Furthermore, both the first resource warehouse and the second resource warehouse corresponding to the target resources can store one or more of the target resources. For example, the merchant has multiple exclusive resource warehouses for merchandise of the same category with each resource warehouse providing storage. In another example, the merchant separately deposits merchandise of the same category into multiple shared resource warehouses managed by a single electronic transaction platform. In yet another example, the merchant separately deposits merchandise of the same category into multiple shared resource warehouses managed by different single electronic transaction platforms.

In addition, the first configuration information of the first resource warehouse includes basic information of the first resource warehouse, e.g., the resource distribution coverage range of the first resource warehouse or area information for the location of the first resource warehouse. Similarly, the second configuration information of the second resource warehouse comprises basic information of the second resource warehouse. Moreover, in some embodiments, the first configuration information and the second configuration information are compatible and consistent with regard to their types. For example, if the resource distribution coverage range of a merchant's exclusive resource warehouse corresponds to the first configuration information, then the second configuration information also corresponds to the resource distribution coverage range of the merchant's shared resource warehouse. In 210, the server acquires and records the first configuration information of the first resource warehouse and the second configuration information of the second resource warehouse.

Next, in 220, the server determines configuration match information of the first resource warehouse and the second resource warehouse based on the first configuration information and the second configuration information. Categories of the configuration match information corresponding to the first resource warehouse and the second resource warehouse should be consistent. The configuration match information includes the results of comparing and relating the first configuration information with the second configuration information. For example, a distribution coverage range of the first resource warehouse corresponds to the first configuration information, and the distribution coverage range is A1, A2, C1 and C2. A distribution coverage range of the second resource warehouse corresponds to the second configuration information, and the distribution coverage range is B1, B2, C1 and C2. A comparison is performed to determine a distribution coverage overlap between the distribution coverage ranges of the two resource warehouses. Thus, the server can obtain an overlapping distribution coverage range of the first resource warehouse and the second resource warehouse being C1 and C2. The server can analyze the overlap information of the configuration coverage range, and determine definite configuration match information. For example, in the case of the first resource warehouse and the second resource warehouse, 50% of the area of their distribution coverage ranges is overlapping. The server determines that the configuration match information of the first resource warehouse and the second resource warehouse corresponds to the distribution coverage range overlap ratio. Furthermore, if the distribution areas corresponding to the first resource warehouse and the second resource warehouse are too large, then a sampling technique can be employed to conduct localized determinations. For example, if warehouse A covers Boston and warehouse B covers Seattle, then one sampling technique includes sampling areas of warehouses A and B and determining whether there is a correlation between the areas of warehouses A and B. In another technique, several addresses are sampled to determine whether matches exist. The sampled addresses cover a large number of consumers. In another example, the area information of the first resource warehouse location corresponds to the first configuration information, e.g., the first resource warehouse is in place E. The area information of the second resource warehouse location corresponds to the second configuration information, e.g., the second resource warehouse is in place F. Thus, the configuration match information of the first resource warehouse and the second resource warehouse can be set as the relatedness between place E and place F, where the two resource warehouses are located. The relatedness can be comprehensively analyzed and determined from multiple parameters such as the distance between the two areas, the time needed to go from place E to place F by a certain mode of transportation, etc. The role herein of the configuration match information includes providing a certain basis for the necessity and reasonableness of merging the first resource warehouse and the second resource warehouse.

A person skilled in the art understands that the distribution coverage ranges and area information of resource warehouse locations are merely examples. If other configuration match information is applied, then the other configuration match information could also be included within the scope of the present application.

In some embodiments, the process 200 further includes operation 260. In 260, the server updates the third resource warehouse based on offline resource allocation information of the first resource warehouse.

In some embodiments, the corresponding target resources in the first resource warehouse include two kinds of dispatch modes: online and offline. For example, the first resource warehouse and the corresponding second resource warehouse establish the third resource warehouse. The resources of the first resource warehouse are provided online in response to resource allocation requests from users having online needs. In addition, the first resource warehouse can also conduct offline transactions. For example, the first resource warehouse is an exclusive resource warehouse whereby a merchant stores target merchandise. The merchant can conduct online transactions involving the target merchandise based on the resource warehouse. The merchant can also conduct synchronized transactions at its stores. In this case, the information relating to the offline resource allocations conducted by the first resource warehouse is to be updated in relation to the third resource warehouse. For example, inventory changes caused by offline allocations are reported in real time in the electronic transaction platform system corresponding to the third resource warehouse. The simultaneous offline-online dispatching by the first resource warehouse increases the modes of resource allocation, resource dispatching capabilities, and resource utilization rates. The real-time updating of simultaneous online-offline resource allocation information also prevents issues such as incompatibilities that can occur in the resource information of the target resources.

In some embodiments, in 220, the server determines the configuration match information of the first resource warehouse and the second resource warehouse based on the first configuration information, the second configuration information, and the resource need distribution information of the first resource warehouse and the second resource warehouse, respectively.

For example, the role of the configuration match information in the example includes performing dispatching for the first resource warehouse and the second resource warehouse, e.g., providing reference information on whether to merge, how to merge, or perform other such operations. For example, the server could compare the distribution areas of the first resource warehouse and the second resource warehouse, respectively, and determine the overlap ratio between the distribution areas. Furthermore, in some embodiments, the configuration match information can be determined based on resource need distribution information of the first resource warehouse and the second resource warehouse, respectively. The resource need distribution information can be determined based on historical resource allocation information of the corresponding resource warehouse. Moreover, parameter information such as resource categories and need time segments can be incorporated into the resource need distribution information. An example of the resource need distribution can be transaction volume of a type of merchandise within a holiday period in the first resource warehouse or the second resource warehouse. At this point, each resource warehouse can have multiple distribution areas, but each distribution area differs relating to target resource need. Some distribution areas could exceed other distribution areas regarding the needs of some target resources. Furthermore, not only does the configuration match information represent a comparison of the distribution areas of the first resource warehouse and the second resource warehouse, but also the configuration match information could incorporate target resource need quantity information from resource warehouses in the overlapping warehouse areas, and relate to the distribution coverage overlap. The higher the distribution coverage overlap between the distribution coverage ranges of each resource warehouse, the higher will be the configuration match information, and thus, following subsequent dispatching adjustments, such as resource warehouse merging, the more resources to be dispatched will exist. Likewise, the greater the demand for resources of the overlapping areas, the more understood the advantage of resource allocation will become based on increased resource dispatching efficiency. For example, one can set weights for the configuration information, such as resource distribution areas, of the first resource warehouse and the second resource warehouse. Areas having large resource needs would have larger weights. This weighting would mean that the configuration match information of the first resource warehouse and the second resource warehouse would be correspondingly higher.

In 230, the server establishes a corresponding third resource warehouse based on the configuration match information. In some embodiments, the third resource warehouse includes resources in the first resource warehouse and the second resource warehouse. To set up certain configuration information for the first resource warehouse and the second resource warehouse, and while conducting comparisons and analyses to obtain configuration match information, the first resource warehouse and second resource warehouse corresponding to configuration match information that has met a certain condition are subject to dispatch consolidation based on actual resource dispatch conditions and objectives. For example, the first and second resource warehouses undergo a resource merger to establish a corresponding third resource warehouse. In some embodiments, the third resource warehouse can be a virtual resource warehouse. Moreover, after the resources of the first resource warehouse and the resources of the second resource warehouse are combined, the combined resources correspond to the resources of the third resource warehouse. Using the resource inventory information corresponding to a resource warehouse as an example, the inventory of a target resource G of a certain merchant corresponds to M pieces in the first resource warehouse. The inventory of target resource G of the certain merchant corresponds to N pieces in the second resource warehouse. Thus, in the third resource warehouse that is established, the inventory of target resource G for the certain merchant corresponds to M+N pieces. In addition, if the configuration match information of the first resource warehouse and the second resource warehouse fails to satisfy a certain condition, the first resource warehouse and the second resource warehouse relating to the target resource could serve as two co-existing resource warehouses for the target resource. The configuration information and target resource information of each resource warehouse would be mutually independent. The resource dispatching of each resource warehouse can be conducted synchronously. For example, regarding resource allocation requests, request A could relate to dispatching from the K′ pieces of target resources in the first resource warehouse, while request B could relate to dispatching from the L′ pieces of target resources in the second resource warehouse. At this point, although a corresponding third resource warehouse has not been established, the simultaneous dispatching of the first resource warehouse and the second resource warehouse could also increase efficiency of the conventional allocation method in which only one resource warehouse was selected for dispatching.

In some embodiments, in 230, when the configuration match information exceeds a predetermined configuration match threshold value, the server establishes a corresponding third resource warehouse. In some embodiments, the third resource warehouse includes the resources in the first resource warehouse and the second resource warehouse.

For example, the configuration match information corresponding to the first resource warehouse and the second resource warehouse relies on basic information for resource dispatching adjustments. When a certain condition is met, resources are consolidated, e.g., resource warehouses are merged. As an example, the condition includes a predetermined configuration match threshold value. The configuration match threshold value corresponds to the configuration match information of each of the resource warehouses. For example, the configuration match information of the resource warehouses corresponds to the distribution coverage ranges of the first resource warehouse and the second resource warehouse. In an example, the distribution coverage overlap of the resource distribution coverage ranges of the first resource warehouse and the second resource warehouse is 50%. Thus, the configuration match threshold value corresponds to a numerical value that relates to the resource distribution coverage range, e.g., a 40% distribution coverage overlap, or a 60% distribution coverage overlap. When the configuration match information exceeds the predetermined configuration match threshold value, the establishment of a corresponding third resource warehouse is to be triggered. On the other hand, when the configuration match information does not exceed the predetermined configuration match threshold value, the first resource warehouse and the second resource warehouse are to each remain independent. In the above example, if the configuration match threshold value corresponds to a distribution coverage overlap of 40%, then a 50% distribution coverage overlap between the resource distribution coverage ranges of the first resource warehouse and the second resource warehouse can satisfy the condition for establishing a corresponding third resource warehouse. However, if the configuration match threshold value corresponds to a distribution coverage overlap of 60%, then a 50% distribution coverage overlap between the resource distribution coverage ranges of the first resource warehouse and the second resource warehouse fails to satisfy the condition for establishing a corresponding third resource warehouse. In another example, the configuration match information of the resource warehouse corresponds to the area information of the first and second resource warehouse locations where the first resource warehouse is located at place E and the second resource warehouse is located at place F. If the relatedness between the two places corresponds to a numerical value related to the actual distance between the two places, then in this case the configuration match threshold value also corresponds to a numerical standard for degrees of relatedness between resource warehouse areas. At this point, the specific data information can be screened and acquired from historical resource allocation information. Also, the factors used to determine the configuration match threshold value can be flexibly set based on different conditions of each resource warehouse in actual dispatching. The following is an example when the configuration match threshold value relates to resource distribution coverage ranges: if a geographical overlap of the areas corresponding to the first and second resource warehouses is not especially large, but the resource needs corresponding to the overlap area are very large, then a lower configuration match threshold numerical value can be set for establishing the merged third resource warehouse. As a result, high resource needs can be met based on merged target resources. In another example, the first resource warehouse and the second resource warehouse have distribution coverage ranges having non-overlapping portions relatively far from each other. If the resource warehouses are merged, and the subsequent dispatching costs between the resource warehouses are relatively high, then the configuration match threshold numerical value can be set higher to reduce the proportion of non-overlapping distribution coverage ranges between the first resource warehouse and the second resource warehouse corresponding to the established third resource warehouse. Higher costs resulting from dispatching between the resource warehouses can thus be avoided. The rationale for using a predetermined configuration match value to define the conditions for resource warehouse merged dispatching is to increase efficiency of the dispatching process and increase the availability of the dispatchable resources.

As an example, when the configuration match information exceeds a predetermined configuration match threshold value that corresponds to a resource category, the server establishes a corresponding third resource warehouse. In some embodiments, the third resource warehouse includes resources of the resource category in the first resource warehouse and the second resource warehouse.

As an example, in actual applications, the categories of target resources stored in the first resource warehouse and the second resource warehouse are not limited to one kind of category. Regarding different target resources in a unified resource warehouse, different types of configuration information can be set up for the different target resources. Using the resource distribution coverage ranges as an example, a single resource distribution coverage range can be applied to all resources within one resource warehouse. In some embodiments, distribution coverage ranges corresponding to different resource categories can be individually set up. For example, the first resource warehouse simultaneously has target resources of category X, category Y, and category Z. Correspondingly, different types of configuration information can be set for the different categories of target resources. For example, the distribution coverage range of category X target resources in the first resource warehouse can be defined as “all distributable in area P,” which corresponds to the first resource warehouse, the distribution coverage range for category Y target resources can be defined as just “partially distributable in area P1,” which corresponds to the first resource warehouse, and the distribution coverage range for category Z target resources can be defined as just “partially distributable in area P2,” which corresponds to the first resource warehouse. Areas P1 and P2 are subsets of distributable area P. Similarly, the target resources of each category in the second resource warehouse are to also have their corresponding specific configuration information. Furthermore, configuration match threshold values are preset corresponding to the resource categories based on the configuration information corresponding to each category of target resource in the resource warehouse. When each category of merchandise in a resource warehouse understandably has a distribution area-related bias, setting things up in such a differentiated way can more flexibly adapt to resource dispatching and allocating resources in actual applications. For example, the configuration information for the resources in the first resource warehouse includes the New York metro area and the Los Angeles metro area where category U merchandise is concentrated in the New York metro area, and category V merchandise is concentrated in the Los Angeles metro area. In this case, to more efficiently and centrally distribute resources, the configuration information for the category U merchandise in the first resource warehouse can be set as the New York metro area, and the configuration information for category V merchandise in the second resource warehouse can be set as the Los Angeles metro area. Then, when target resources U and V in the first resource warehouse undergo configuration match information determination with respect to target resources U and V in the second resource warehouse, if the configuration match information corresponds to a distribution coverage overlap, the configuration information characteristics of the target resources U and V will be understood. A third resource warehouse is to be established when the configuration match threshold value is satisfied, and resource dispatching is to become better targeted. When the resource categories in certain resource warehouses have obvious distribution area-related biases, resource warehouse configuration information and configuration match threshold values are set up that correspond to those resource categories. This allows for an increase in flexibility in the allocation of resource dispatching effectiveness throughout the resource warehouses and leads to an increase in matches between needs and resources.

By matching the first resource warehouse and the second resource warehouse corresponding to the same resource based on the configuration information of each resource warehouse, the server establishes a third resource warehouse that simultaneously includes the resources of the first resource warehouse and second resource warehouse and thus expands and increases the efficiency of the allocation range of the target resources. In this way, resource allocation efficiency is increased.

In some embodiments, the process 200 further includes:

In 240, the server presents basic resource information of resources in the third resource warehouse.

In some embodiments, the basic resource information includes the resource category information in the third resource warehouse, the inventories of the resources, the sources of resource inventories, information on resource allocations that have already occurred, etc. The basic resource information of the resources in the third resource warehouse is a summation and merger of the basic resource information including resources in the first resource warehouse and the second resource warehouse. Many ways in which the basic resource information can be presented exist. For example, the basic resource information is presented on a network user terminal, such as a computer or a mobile network terminal, providing the basic resource information of target resources in the third resource warehouse to a user in need. For example, if the basic resource information corresponds to resource inventory, then the resource inventory information in the third resource warehouse includes a sum of resource inventory information in the first resource warehouse and the second resource warehouse, which can be merged and provided to the user in need. In another example, the basic resource information includes resource inventory source information in the third resource warehouse. For example, there are areas and other related information for the real first resource warehouse and the real second resource warehouse corresponding to the third resource warehouse of the resource sources, and inventory information relating to each individual resource source exists. At the same time, depending on the allocation and dispatching conditions of the resources, the resource inventory in the resource warehouse can be updated in real time. Thus, users in need can be provided with relatively comprehensive basic resource information as a reference. For example, a certain type of merchandise in place S is produced with the best quality. In that case, the user learns through a page that the target resource warehouse of the merchandise is place S. Assuming that the target resource warehouse address can be related to the merchandise place of origin, the user can, to a certain extent, place more trust in the target resource warehouse of the resource corresponding to the place S than in target resource warehouses of other areas. And the placing of more trust in the target resource warehouse in place S can lead to selection bias. In an actual application, another situation also exists. In other words, to provide users in need with the most streamlined user experiences, the specific real resource warehouse information that is associated with resources that are to be allocated may not be manifested at the application front end. For example, when merchandise information is viewed during an online transaction, basic resource information such as merchandise category and inventory can receive special attention, though the source resource warehouse information for the merchandise may not be displayed. Therefore, the specific types of basic resource information of resources in the third resource warehouse can be flexibly set based on specific application scenarios.

In some embodiments, in 230, the server determines the third configuration information of the third resource warehouse based on the first configuration information and the second configuration information. In some embodiments, in 240, the server presents basic resource information of resources in the third resource warehouse and the third configuration information.

For example, the third resource warehouse includes the resources in the first resource warehouse and the second resource warehouse. In a specific resource allocation and dispatching, the third configuration information of the third resource warehouse can include the configuration information corresponding to the target resources in the first resource warehouse and the second resource warehouse. For example, using the configuration information including the resource distribution coverage ranges as an example, the resource distribution coverage ranges corresponding to the first resource warehouse W1 are R1, R2, R3 and R4, and the resource distribution coverage ranges corresponding to the second resource warehouse W2 are R1, R2, R5 and R6. Thus, the third configuration information of the third resource warehouse W3 is to have resource distribution coverage ranges R1, R2, R3, R4, R5 and R6. Furthermore, in 240, the server presents the basic resource information of the resources in the third resource warehouse and the third configuration information. For example, in the above basic resource information of the first resource warehouse W1, the inventory information is e1, and the inventory information of the second resource warehouse W2 is e2. Thus, the target merchandise inventory quantity of e1+e2 to users in need can be presented through computer pages or mobile device terminals. The corresponding configuration information can be distributed to areas R1, R2, R3, R4, R5, and R6. In addition, as necessary, the target merchandise inventory quantities and the correspondences to the resource warehouses to users in need can be presented for their browsing reference. For example, the inventory of target merchandise e1 corresponds to first resource warehouse W1 and is paired with the basic information of the first resource warehouse, etc.

In some embodiments, the process 200 further includes operation 250. In 250, the server allocates corresponding resources in the first resource warehouse or the second resource warehouse based on resource allocation requests associated with resources in the third resource warehouse.

For example, the third resource warehouse includes the resources in the first resource warehouse and the second resource warehouse. In some embodiments, the basic resource information of resources in the third resource warehouse and the third configuration information are to be presented at the network front-end, e.g., a computer page or a portable terminal. The user in need is to issue a corresponding resource allocation request based on the resource-related information that is displayed. Typically, since the third resource warehouse is merely a virtual resource warehouse, the resource allocation request that is sent based on the basic resource information of the third resource warehouse and the third configuration information that are presented is to ultimately be routed to the ascertained real resource warehouse, such as the first resource warehouse or the second resource warehouse. With respect to the target resources of the resource allocation request, corresponding resources are to be searched in the first resource warehouse or the second resource warehouse. Subsequently, the corresponding resources in the specific, routed-to resource warehouse are allocated. For example, the user browses, based on an electronic transaction platform, the basic resource information and corresponding configuration information, such as merchandise inventory and specific shipment area ranges, for target merchandise displayed on a transaction web page. Moreover, the user issues a resource allocation request, e.g., places a shopping order. The server responds to the allocation request and determines and routes to the ascertained shipment warehouse based on the selection. Arrangements are made to release and ship the corresponding target merchandise from the shipment warehouse.

In some embodiments, in 250, the server determines which of the first resource warehouse or the second resource warehouse is the corresponding target resource warehouse based on a resource allocation address corresponding to the resource allocation request.

The corresponding resource in the target resource warehouse is allocated to the resource allocation address.

In some embodiments, the server determines the resource allocation address corresponding to the resource allocation request. The resource allocation request can be, for example, a transaction order submitted by a consumer on an electronic transaction platform while performing merchandise transactions. The determination of the resource allocation address is based at least in part on the resource allocation request issued by the user. The resource allocation request includes the categories and quantities and other information relating to request target merchandise. In addition, the user can select the resource allocation address based on a resource distribution coverage range managed by the server, e.g., distribution address options displayed by the merchandise information page. In some embodiments, the server can automatically set the resource allocation address of the target merchandise selected by the target user. For example, the server fetches the default receiving address set by the target user and recorded on the electronic transaction platform or fetches the receiving address that appears most frequently in the transaction records of the user over a period of time and regards the default receiving address set as the resource allocation address corresponding to the resource allocation request. Based on the resource allocation address corresponding to the resource allocation request, the device 100 is to display for the user precise target merchandise information, e.g., the inventory of target merchandise that satisfies the resource allocation request. In some embodiments, the device 100 can also display information relating to the specific resource warehouse corresponding to the inventory. After the transaction order is confirmed by the user, a determination is to be made as to which of the first resource warehouse or the second resource warehouse corresponding to the target merchandise is the corresponding target merchandise warehouse. Afterwards, the resources that correspond to the resource allocation request and that are in the target resource warehouse are allocated to the resource allocation address.

For example, the resources corresponding to the resource allocation request are allocated based on the specific target resource warehouse that was ascertained through a second routing to the resource allocation address. First of all, based on the target merchandise and the resource allocation request corresponding to the target merchandise, a preliminary determination is made that the actual shipment warehouse is the third resource warehouse or that the actual shipment warehouse is an independent first resource warehouse or second resource warehouse that was not merged into the third resource warehouse, and first routing information is recorded in the transaction order for the target merchandise. Furthermore, based on the transaction order and the consumer payment facts, a logistics order for the corresponding target merchandise is created. A second routing is performed based on the warehouse information in the logistics order. If the logistics order only corresponds to an independent first resource warehouse or second resource warehouse that was not merged into the third resource warehouse, then the logistics order is sent directly to the corresponding resource warehouse to arrange the shipping matters. If the logistics order corresponds to the third resource warehouse of the target merchandise, then matching is performed based on the specific resource configuration address, and arrangements are made for shipping from either the first resource warehouse or the second resource warehouse corresponding to the target merchandise third resource warehouse. For example, the distribution coverage range of the first resource warehouse corresponding to the third resource warehouse is P1, P2 and P3, and the distribution coverage range of the corresponding second resource warehouse is P1, P2 and P4. If the resource allocation address corresponding to the current resource allocation request is P3, then the priority arrangement is to be for the first resource warehouse to serve as the target resource warehouse. If the resource allocation address is P4, then the priority arrangement is for the second resource warehouse to serve as the target resource warehouse. If the resource allocation address is P1 or P2, and both the first resource warehouse and the second resource warehouse have the corresponding inventory, then either the first resource warehouse or the second resource warehouse can be selected as the target resource warehouse. In some embodiments, a corresponding target resource warehouse can be selected based on actual operational convenience. In addition, the first resource warehouse and the second resource warehouse corresponding to the third resource warehouse can also engage in mutual, supplementary dispatching during actual resource dispatching. In the above example, the resource allocation address corresponding to the resource allocation request is P3. In principle, priority is to be given to arrange for the first resource warehouse to serve as the target resource warehouse. As an aspect, if at this time the inventory of the target resource corresponding to the first resource warehouse is 0, and if the inventory of the target resource corresponding to the second resource warehouse is m, then the server can arrange for the second resource warehouse to complete distribution of the target resource to complete the dispatching of the target resource. In some embodiments, the server can choose first to dispatch the corresponding target resource in the second resource warehouse to the corresponding first resource warehouse and then perform distribution of the target resource from the first resource warehouse.

FIG. 3 is a diagram of an embodiment of a system for dispatching resources. In some embodiments, the system 300 includes a server 310 connected to a client 330, a first resource warehouse management agent 340, a second resource warehouse management agent 350, and a third resource warehouse 360 via a network 320.

In some embodiments, the first resource warehouse management agent 340 and the second resource warehouse management agent 350 are located on the same server as the server 310. In some embodiments, the first resource warehouse management agent 340 and/or the second resource warehouse management agent 350 are located on a separate server as the server 310.

The first resource warehouse management agent 340 manages contents of a first resource warehouse 345, and the second resource warehouse management agent 350 manages contents of a second resource warehouse 355.

In some embodiments, the server 310 acquires first configuration information of a first resource warehouse 340 and second configuration information of a second resource warehouse 350, determines configuration match information of the first resource warehouse 340 and the second resource warehouse 350 based on the first configuration information and the second configuration information, and in the event that the configuration match information exceeds a predetermined configuration match threshold value, establishes a corresponding third resource warehouse 360 based on the configuration match information. In some embodiments, the third resource warehouse 360 is a virtual resource warehouse and includes resources in the first resource warehouse and the second resource warehouse.

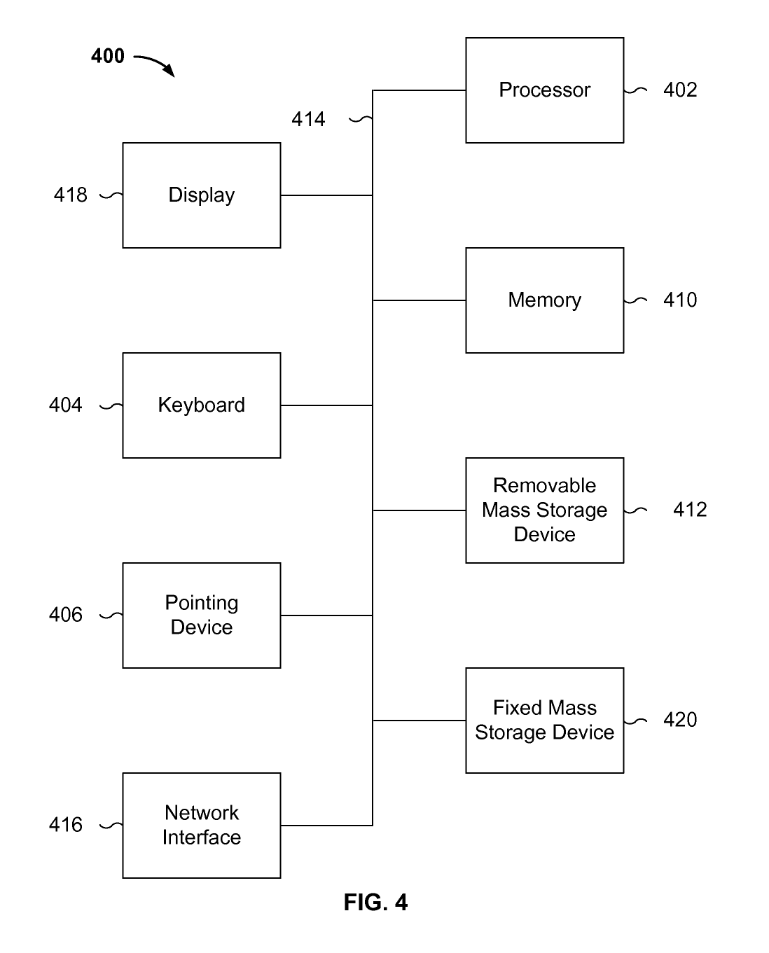

FIG. 4 is a functional diagram illustrating an embodiment of a programmed computer system for dispatching resources. As will be apparent, other computer system architectures and configurations can be used to dispatch resources. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418).

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown).

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storages 412, 420 generally store additional programming instructions, data, and the like that typically are not in active use by the processor 402. It will be appreciated that the information retained within mass storages 412 and 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
acquiring first configuration information of a first resource warehouse and second configuration information of a second resource warehouse, wherein the first and second resource warehouses correspond to physical warehouses;
determining configuration match information of the first resource warehouse and the second resource warehouse based on the first configuration information and the second configuration information; and
in the event that the configuration match information exceeds a predetermined configuration match threshold value, establishing a corresponding third resource warehouse based on the configuration match information, wherein the third resource warehouse is a virtual resource warehouse and includes resources in the first resource warehouse and the second resource warehouse.

2. The method as described in claim 1, further comprising:
presenting basic resource information of resources in the third resource warehouse to a user.

3. The method as described in claim 2, wherein:
the establishing of the corresponding third resource warehouse comprises:
determining third configuration information of the third resource warehouse based on the first configuration information and the second configuration information; and
the basic resource information of the resources in the third resource warehouse comprises the third configuration information.

4. The method as described in claim 1, further comprising:
allocating corresponding resources in the first resource warehouse or the second resource warehouse based on a resource allocation request relating to a resource in the third resource warehouse.

5. The method as described in claim 4, wherein the allocating of the corresponding resources in the first resource warehouse or the second resource warehouse comprises:
determining which of the first resource warehouse and the second resource warehouse is a corresponding target resource warehouse based on a resource allocation address corresponding to the resource allocation request, the corresponding resource in the target resource warehouse being allocated to the resource allocation address.

6. The method as described in claim 1, wherein the predetermined configuration match threshold value corresponds to a resource category, and the third resource warehouse comprises resources of the resource category in the first resource warehouse and the second resource warehouse.

7. The method as described in claim 1, further comprising:
updating the third resource warehouse based on offline resource allocation information of the first resource warehouse.

8. The method as described in claim 1, wherein the determining of the configuration match information of the first resource warehouse and the second resource warehouse comprises:
determining the configuration match information of the first resource warehouse and the second resource warehouse based on the first configuration information, the second configuration information, resource need distribution information of the first resource warehouse, and resource need distribution information of the second resource warehouse.

9. The method as described in claim 1, wherein the configuration match threshold value corresponds to a distribution coverage overlap threshold.

10. The method as described in claim 1, further comprising:
in the event that a geographical overlap of areas corresponding to the first resource warehouse and the second resource warehouse falls below a geographic overlap threshold and resource needs corresponding to the overlapping area exceeds a need threshold, decreasing the predetermined configuration match threshold value to trigger an establishment of a merged third resource warehouse.

11. The method as described in claim 4, wherein the allocating of the corresponding resources in the first resource warehouse or the second resource warehouse includes allocating the resources through a second routing.

12. A system, comprising:
at least one processor configured to:
acquire first configuration information of a first resource warehouse and second configuration information of a second resource warehouse, wherein the first and second resource warehouses correspond to physical warehouses;
determine configuration match information of the first resource warehouse and the second resource warehouse based on the first configuration information and the second configuration information; and
in the event that the configuration match information exceeds a predetermined configuration match threshold value, establish a corresponding third resource warehouse based on the configuration match information, wherein the third resource warehouse is a virtual resource warehouse and includes resources in the first resource warehouse and the second resource warehouse; and
a memory coupled to the at least one processor and configured to provide the at least one processor with instructions.

13. The system as described in claim 12, wherein the at least one processor is further configured to:
present basic resource information of resources in the third resource warehouse to a user.

14. The system as described in claim 13, wherein:
the establishing of the corresponding third resource warehouse comprises to:
determine third configuration information of the third resource warehouse based on the first configuration information and the second configuration information; and
the basic resource information of the resources in the third resource warehouse comprises the third configuration information.

15. The system as described in claim 12, wherein the at least one processor is further configured to:
allocate corresponding resources in the first resource warehouse or the second resource warehouse based on a resource allocation request relating to a resource in the third resource warehouse.

16. The system as described in claim 15, wherein the allocating of the corresponding resources in the first resource warehouse or the second resource warehouse comprises to:
determine which of the first resource warehouse and the second resource warehouse is a corresponding target resource warehouse based on a resource allocation address corresponding to the resource allocation request, the corresponding resource in the target resource warehouse being allocated to the resource allocation address.

17. The system as described in claim 12, wherein the determining of the configuration match information of the first resource warehouse and the second resource warehouse comprises to:
determine the configuration match information of the first resource warehouse and the second resource warehouse based on the first configuration information, the second configuration information, resource need distribution information of the first resource warehouse, and resource need distribution information of the second resource warehouse.

18. The system as described in claim 12, wherein the configuration match threshold value corresponds to a distribution coverage overlap threshold.

19. The system as described in claim 12, further comprising to:
in the event that a geographical overlap of areas corresponding to the first resource warehouse and the second resource warehouse falls below a geographic overlap threshold and resource needs corresponding to the overlapping area exceeds a need threshold, decrease the predetermined configuration match threshold value to trigger an establishment of a merged third resource warehouse.

20. A computer program product being embodied in a tangible non-transitory computer readable storage medium and comprising computer instructions for:
acquiring first configuration information of a first resource warehouse and second configuration information of a second resource warehouse, wherein the first and second resource warehouses correspond to physical warehouses;
determining configuration match information of the first resource warehouse and the second resource warehouse based on the first configuration information and the second configuration information; and
in the event that the configuration match information exceeds a predetermined configuration match threshold value, establishing a corresponding third resource warehouse based on the configuration match information, wherein the third resource warehouse is a virtual resource warehouse and includes resources in the first resource warehouse and the second resource warehouse.
